(19) United States
(12) Patent Application Publication
(10) Pub. No.: US 2013/0278845 A1
(43) Pub. Date: Oct. 24, 2013

(54) EMBEDDED ELECTROOPTICAL DISPLAY

(71) Applicants: Oleg Pishnyak, Akron, OH (US); Andrew DeMiglio, Kent, OH (US); Tod Schneider, Kent, OH (US); Donald Davis, Conneaut Lake, PA (US); Mathew Bowser, Hubbard, OH (US); Erica Montbach, Kent, OH (US)

(72) Inventors: Oleg Pishnyak, Akron, OH (US); Andrew DeMiglio, Kent, OH (US); Tod Schneider, Kent, OH (US); Donald Davis, Conneaut Lake, PA (US); Mathew Bowser, Hubbard, OH (US); Erica Montbach, Kent, OH (US)

(73) Assignee: Kent Displays Incorporated, Kent, OH (US)

(21) Appl. No.: 13/449,781

(22) Filed: Apr. 18, 2012

(51) Int. Cl. B29C 35/08; G02F 1/13; G02F 1/1334

(52) U.S. Cl. CPC B29C 35/0805; G02F 1/1334; G02F 1/1313
USPC 349/12; 349/88; 264/496

(57) ABSTRACT

This disclosure features embedded electrooptical displays such as liquid crystal displays and methods of making the same. The displays are embedded in light curable material on one or both sides thereof. Processes for embedding the displays include injection molding and continuous roll-to-roll processing. The light curable material forms a protective covering over the display. Electrical interconnects connected to electrodes of the display can protrude from the protective layer. Once the display is embedded it can resist contact with moisture and mechanical damage. The protective layer can be clear or it can contain additives such as pigments or additives for UV protection. The embedded display with the protective layer may be molded into different shapes during the embedding process or thermoformed after the embedding process into different shapes. This permits the embedded display to be adapted into a variety of different electronic devices such as cell phones, smart phones, MP-3 players, a computer mouse, etc.

### FIELD OF THE INVENTION

This disclosure pertains to an embedded electrooptical display and, in particular, to a liquid crystal display embedded in a light curable material.

### BACKGROUND OF THE INVENTION

A reflective cholesteric liquid crystal display made from flexible substrates for various commercial applications often requires further ruggedization to prevent mechanical damage. The display device should be protected from abrasion, mechanical impact, pressure points, chemicals, and environmental factors such as UV light and moisture. A protective film can be attached by lamination to the front, or to the front and back, of the display with pressure sensitive adhesive (PSA), for example; however, the laminated display becomes rather rigid. Another approach to protect the display is through an injection molding process where a heat curable resin is formed on the front of the product as described in U.S. Pat. No. 5,993,588 and U.S. patent application Ser. No. 12/758,026. Forming an optically clear protective layer on the front of the device by an injection molding process requires high pressures and temperatures that often result in physical damage to the display, which is composed of flexible plastic substrates such as polyethylene terephthalate (PET), polycarbonate (PC), polyethylene naphthalate (PEN) or other plastic material, as well as heat sensitive liquid crystal material.

### BRIEF DESCRIPTION OF THE INVENTION

Light curable flexible material that maintains display flexibility and avoids damage due to exposing the display to high temperatures and high pressure can be used for display ruggedization. Light curable materials are used in a method for embedding an electrooptical display in a protective (e.g., optically clear) durable layer that has many advantages. The method is fast, inexpensive, can embed electrooptical displays by molding in a batch process or in a roll-to-roll production process, and does not require high pressures or temperatures that are described in U.S. patent application Ser. Nos. 10/285,189 and 10/456,021. In U.S. Pat. No. 7,401,758 and U.S. patent application Ser. No. 12/758,026 is described an object with a display embedded into a top surface of the object. The display may have a durable layer on its front surface and light curable material layer on the back. In the present disclosure is described a method for embedding the flexible cholesteric reflective display (e.g., fully embedding from the front and back sides) into a skin-like protective optically clear layer of radiation curable resin. The method results in a stand alone display embedded into a durable layer of clear light curable resin. The method is compatible with a roll-to-roll manufacturing process.

A method of forming an optically clear protective casing based on light curing technology which embeds a flexible cholesteric liquid crystal display made from plastic substrates is disclosed. The process comprises: 1) placing the display into an optically transparent mold made from silicone, acrylic or some other optically transparent material; 2) filling the cavity of the mold with light curable material; 3) forming a protective layer on top of the display by curing the light curable material by adding light; 4) if full encapsulating is required then the display is taken out of the mold, turned upside down and steps #1-3 are repeated for the bottom side. The process is also applicable to a single step injection mold where the display is fully encapsulated from both front and back in one step by flowing the light curable material along the bottom and top of the display simultaneously and then curing the light curable material by adding light. The displays can be embedded also through a process flowing the light curable material along the bottom and top of the display between two plastic films or substrates, which can be released from the embedded display after the light curable material is cured or can become a part of the protective casing.

The formed protective casing can be rigid or flexible depending on the choice of light curable material which offers many options for integration with consumer electronic devices. In addition, the light curable materials can be doped with additives such as dyes, filler materials such as carbon nanotubes, glass or plastic spheres or rods. Light curable materials can be also doped with thermally activated initiators such as trimellitic anhydride (TMA) to modify the elastic modulus (stiffness) of the film with a post cure baking process. Post cure baking is used for thermally activated dopants only.

The protective casing can be of various shapes depending on the application: flat or curved; in the shape of a protective skin-like case for a cell phone or MP3 player, as the mold cavity dictates the shape of the final part. A protective casing can also be formed in a roll-to-roll process: the display is carried between two plastic films or substrates on a roll-to-roll line with light curable material in between. Then the protective layer which encapsulates the display is formed by irradiation of the light curable material between the substrates in a light curing zone. Plastic substrates can be substituted with release liners and removed after forming the protective casing. However, the encapsulated display would not be left with adhesive on it. Again, the protective casing can be formed on front or back sides of the displays or on both front and back sides of the display device if full encapsulation is desired utilizing a roll-to-roll line. The protective casing formed during the roll-to-roll process usually has flat outer surfaces; however curved shapes can be formed further from the parts made in roll-to-roll process by thermoforming, for example, if thermoformable plastic or thermoformable (thermoset) light sensitive resin or both are used for display embedding.

The formed casing may be tinted with dye or pigment to achieve a desired color and include decorative graphics or text or both. UV absorbing additives may be added to the protective casing material to protect the display from ambient UV light. The protective casing coupled with a display is ready to be placed on top or integrated with consumer electronic devices such as cell phones, MP3 players, smart cards, etc. Flexible displays embedded into a flexible protective polymer matrix can conform to different curvatures and form a display “skin” which can be wrapped around a wrist forming a switchable bracelet, for example, placed on top of a computer mouse, or used in other consumer electronic devices.

Summarizing, the process of embedding a cholesteric liquid crystal display made from flexible substrates into a light curable optically clear polymer matrix (casing) is disclosed. The formed matrix fully encapsulates the display sealing the edges and protects the display from mechanical damage and exposure to the environment. The formed module (display with protective casing) can be used or integrated with various consumer electronic devices.

Turning now to specific aspects of the disclosure, one aspect features a method of forming an embedded electrooptical display comprising providing a mold that defines a cavity therein, wherein at least a portion of the mold is light transmissive. An electrooptical display is placed in the mold. Light curable material is flowed into the cavity of the mold on and around the electrooptical display. Light is applied through the light transmissive portion of the mold that cures the light curable material into a protective layer on and around the display forming an embedded electrooptical display. The embedded electrooptical display is removed from the mold.

Referring to specific features of the first aspect of the disclosure an electrical interconnect can extend from the electrooptical display. The light curable material can be prevented from contacting the electrical interconnect while the electrooptical display is in the mold. The electrooptical display can include an upper surface and a lower surface and only one of the upper surface and the lower surface can contact light curable material. The electrooptical display can include an upper surface and a lower surface and both the upper surface and said lower surface can contact the light curable material. A portion of the mold can cover the electrical interconnect preventing the light curable material from contacting the electrical interconnect when the electrooptical display is in the mold. The electrical interconnect can be covered with a non-stick material that the light curable material does not adhere to, comprising removing the light curable material adjacent the non-stick material (and optionally removing the non-stick material) to expose the electrical interconnect after the electrooptical display is removed from the mold. The electrooptical display can be a liquid crystal display comprising two substrates each in contact with a layer of electrically conductive material and liquid crystal material disposed between the layers of electrically conductive material. The liquid crystal display can include bistable cholesteric liquid crystal material. The protective layer and the electrooptical display can be flexible which enables the embedded electrooptical display to be flexible. The protective layer can be optically clear. The protective layer can be in contact with the electrooptical display.

Still further, the protective layer can be formed on one side of the electrooptical display. The electrooptical display can be removed from the mold. The electrooptical display can be flipped over. The electrooptical display can be inserted into the mold so that the other side of the electrooptical display is exposed. Light curable material can be flowed into the cavity of the mold on the other side of the electrooptical display and around the electrooptical display into contact with the previously cured protective layer. Light can be applied through the light transmissive portion of the mold that cures the light curable material into a protective layer on the other side of the electrooptical display and around the electrooptical display forming a fully embedded electrooptical display. The fully embedded electrooptical display can be removed from the mold. The mold can include mold sections that contact each other and the portion of the mold that covers the electrical interconnect can includes a notch in one or both of the mold sections that receives the electrical interconnect. The mold sections can be in contact with each other outside of the notch.

Referring to a second aspect of this disclosure a method of forming embedded electrooptical displays comprises pulling a first substrate under tension over rollers. A plurality of spaced apart electrooptical displays can be placed in fixed positions on the first substrate. Light curable material is flowed onto the electrooptical displays and onto the first substrate around the electrooptical displays. A second light transmissive substrate can be placed on the light curable material. Pressure can be applied that forces the first substrate and the second substrate toward each other. Light can be applied through at least one of the first substrate and the second substrate that cures the light curable material into a protective layer on and around the electrooptical displays forming embedded electrooptical displays. Individual embedded electrooptical displays can be cut from the cured protective layer.

Referring to specific features of the second aspect, an electrical interconnect can extend from each of the electrooptical displays outside of the light curable material. The light curable material can be prevented from contacting the electrical interconnects while the electrooptical displays are between the first and second substrates. The first and second substrates can be removed from the electrooptical displays. Each of the electrooptical displays can include an upper surface and a lower surface and only one of the upper surface and the lower surface can contact the light curable material.

Still further, the method can include flipping the first and second substrates over so that the second substrate is supported on the rollers. The first substrate is removed. The light curable material is applied on the electrooptical displays and on the protective layer around the electrooptical displays. A light transmissible third substrate is placed on the light curable material. Pressure is applied moving the second substrate and the third substrate toward each other. Light is applied through the at least one of the second substrate and the third substrate that cures the light curable material into a second portion of the protective layer on the electrooptical displays.

Still further, the cutting can occur through the protective layer and the second portion of the protective layer. The electrooptical displays can be liquid crystal displays each comprising two substrates each in contact with a layer of electrically conductive material and liquid crystal material disposed between the layers of electrically conductive material. The liquid crystal material can include bistable cholesteric liquid crystal material. The protective layer and the electrooptical displays can be flexible which enables the embedded electrooptical displays to be flexible. The first and second substrates can be unwound from rolls. The protective layer can be optically clear. The method can include comprising inhibiting flow of the light curable material from sides between the first substrate and the second substrate with shims.

Referring to a third aspect of this disclosure a method of forming embedded electrooptical displays comprises placing a plurality of spaced apart first mold portions on rollers, each of the first mold portions defining a cavity. Light curable material is flowed into the cavities of the first mold portions. Electrooptical displays are placed on the light curable material in the first mold portions. A plurality of spaced apart second mold portions are provided, each of the second mold portions defining a cavity. Light curable material is flowed into the cavities of the second mold portions. The second mold portions are aligned with the first mold portions. Pressure is applied moving the first mold portions and the second mold portions toward each other so that the light curable material is disposed on both sides of the electrooptical displays. Light is applied through at least one light transmissive portion of the first mold portions and second mold portions that cures the light curable material into a protective layer on and around the electrooptical displays forming embedded electrooptical displays. The embedded electrooptical displays are cut from the protective layer. The first mold portions and the second mold portions are removed.

Referring to specific features of the third aspect, an electrical interconnect can extend from each electrooptical display which is sandwiched between the first mold portions and second mold portions. The light curable material is prevented from contacting the electrical interconnects while the electrooptical displays are disposed between the first and second mold portions. The electrooptical display can be a liquid crystal display comprising two substrates each in contact with a layer of electrically conductive material and liquid crystal material disposed between the layers of electrically conductive material. The liquid crystal display can include bistable cholesteric liquid crystal material. The protective layer and the electrooptical displays can be flexible which enables the embedded electrooptical displays to be flexible. The first and second mold portions can each comprise a sheet having the cavities as cutouts on the sheet that is adhered to a first substrate and to a second substrate, respectively. The first and second substrates can form the light transmissive portions.

Referring to a fourth aspect of the disclosure a method of forming an embedded electrooptical display comprises placing an electrooptical display between two mold sections each forming a cavity. At least one of the mold sections is light transmissive. The electrooptical display includes an electrical interconnect. Each of the mold sections includes an inlet port and a vent. The mold sections are secured together so that the electrical interconnect is sandwiched between the mold sections and a portion of the electrooptical display near the inlet ports is near a center of the mold. Light curable material is injected into the inlet ports to flow into the mold sections simultaneously above and below the electrooptical display. Light is applied through the at least one light transmissive mold section to cure the light curable material into a protective layer on both sides of the electrooptical display but not on the electrical interconnect. The embedded electrooptical display is removed from the mold.

Referring to a fifth aspect of the disclosure a method of forming an embedded electrooptical display includes providing a lower shim enclosing a cavity and a lower film on which the lower shim is supported. Light curable material is flowed in the cavity in the lower shim onto the lower film. An electrooptical display is placed on the light curable material in the lower shim. An upper shim is provided enclosing a cavity above the electrooptical display. Light curable material is flowed in the cavity in the upper shim onto the electrooptical display. An upper film is provided in contact with the upper shim. Pressure is applied moving the upper shim toward the lower shim so that the light curable material is disposed on both sides of the electrooptical display. Light is applied through at least one light transmissive portion of at least one of the upper shim, the lower shim, the upper film and the lower film that cures the light curable material into a protective layer on and around the electrooptical display forming an embedded electrooptical display. The upper shim, the upper film, the lower shim and the lower film are removed from the embedded electrooptical display. Referring to a specific feature of this aspect of the invention, an electrical interconnect of the electrooptical display can be placed between the upper shim and the lower shim to prevent the electrical interconnect from being covered with the light curable material.

Referring to a sixth aspect of the disclosure a flexible embedded electrooptical display comprises an electrooptical display embedded on at least one side of the electrooptical display in a protective layer comprising light cured polymeric material, with the proviso that there is no adhesive layer in contact with the electrooptical display.

Referring to specific features of the sixth aspect, the protective layer includes a first protective layer portion on one side of the electrooptical display and a second protective layer portion on another side of the electrooptical display. The first protective layer portion and the second protective layer portion form an integral body surrounding the electrooptical display.

Still further, the light cured material can be optically clear. The electrooptical display can be a liquid crystal display comprising two substrates each in contact with a layer of electrically conductive material and liquid crystal material disposed between the layers of electrically conductive material. The liquid crystal material can include bistable cholesteric liquid crystal material. An electrical interconnect can be connected to the electrooptical display that includes a tab portion that is not embedded in the light curable polymeric material. The electrical interconnect can be electrically attached to the electrically conductive layers of the electrooptical display. The electrically conductive layers can include parallel lines of row electrodes on the one side of the liquid crystal material and parallel lines of column electrodes on the other side of the liquid crystal material, the row electrodes being substantially orthogonal to the column electrodes. On the other hand, each of the electrically conductive layers can form an unpatterned sheet across a viewing area of the electrooptical display. The display can be a pressure sensitive writing tablet in which one of the substrates upon which writing pressure is applied is exposed from the protective layer. A device incorporating the embedded electrooptical display can be selected from the group consisting of a cell phone, smart phone, an MP-3 player, a computer mouse, a credit or debit card, an identification badge, a wall tile, a laptop cover, a bracelet, etc.

The embedded display can be bent at a radius of curvature R (or curvature k=1/R), wherein the radius of curvature ranges from 10 mm to less than infinity (a flat unbendable surface) or from −10 mm to less than infinity and in particular, from 10 mm to 70 mm or from −10 mm to −70 mm. The positive and negative values for radius of curvature mean that the embedded display can bend in opposite directions.

Relative terms such as upper, lower, front and back, have been used in this disclosure but should not be interpreted to limit the claimed invention. These terms are relative and are dependent on the position of display and its orientation which can change.

Many additional features, advantages and a fuller understanding of the invention will be had from the accompanying drawings and the detailed description that follows. It should be understood that the above Brief Description of the Invention describes the invention in broad terms while the following Detailed Description describes the invention more narrowly and presents specific embodiments that should not be construed as necessary limitations of the invention as broadly defined in the claims.

### BRIEF DESCRIPTION OF THE DRAWINGS

FIG. 1a: Perspective view of a mold process of forming a protective casing encapsulating a cholesteric liquid crystal display.

FIG. 1b: Top view of the cholesteric liquid crystal display inside the mold cavity of FIG. 1a.

FIG. 1c: Schematic view of attaching an electronic interconnect to a cholesteric liquid crystal display used in the mold of FIG. 1a and in other processes of this disclosure.

FIG. 2: Side view of a mold process of forming a protective casing fully embedding a cholesteric liquid crystal display.

FIG. 3a: Side view of a laminating process of forming a protective casing fully embedding a cholesteric liquid crystal display.

FIG. 3b: Schematic view of a shim used in laminating process of FIG. 3a.

FIG. 4a: Schematic top view of a cholesteric liquid crystal display embedded into a polymer matrix.

FIG. 4b: Side cross-section of a cholesteric liquid crystal display fully embedded into a polymer matrix.

FIG. 4c: Schematic view of a cholesteric liquid crystal display fully embedded into a flexible polymer matrix that can be conformed to some curvature.

FIG. 5a: Schematic top view of a cholesteric liquid crystal display embedded into a polymer matrix in the shape of case for a cell phone or MP3 player device.

FIG. 5b: Schematic side view of a cholesteric liquid crystal display embedded on top and bottom surfaces into a polymer matrix from FIG. 5a.

FIG. 5c: Perspective view of a cholesteric liquid crystal display embedded into a flexible polymer matrix from FIG. 5a and subjected to twist deformation.

FIG. 5d: Schematic side view of a cholesteric liquid crystal display embedded only on a bottom surface into a polymer matrix from FIG. 5a.

FIG. 6a: Side view of a roll-to-roll process of forming the protective casing on a top side of the display.

FIG. 6b: Schematic top view of the displays in the roll-to-roll process of FIG. 6a.

FIG. 7a: Side view of a roll-to-roll process of forming the protective casing on top and bottom sides of the display in a one step process.

FIG. 7b: top view of the displays positioned in the process shown in FIG. 7a.

FIG. 7c: a top view of the embedded display formed from the method of FIG. 7a.

FIG. 8a: Side view of a roll-to-roll process of forming the protective casing embedding the display.

FIG. 8b: Schematic top view of the displays in the roll to roll process of FIG. 8a.

### DETAILED DESCRIPTION OF THE INVENTION

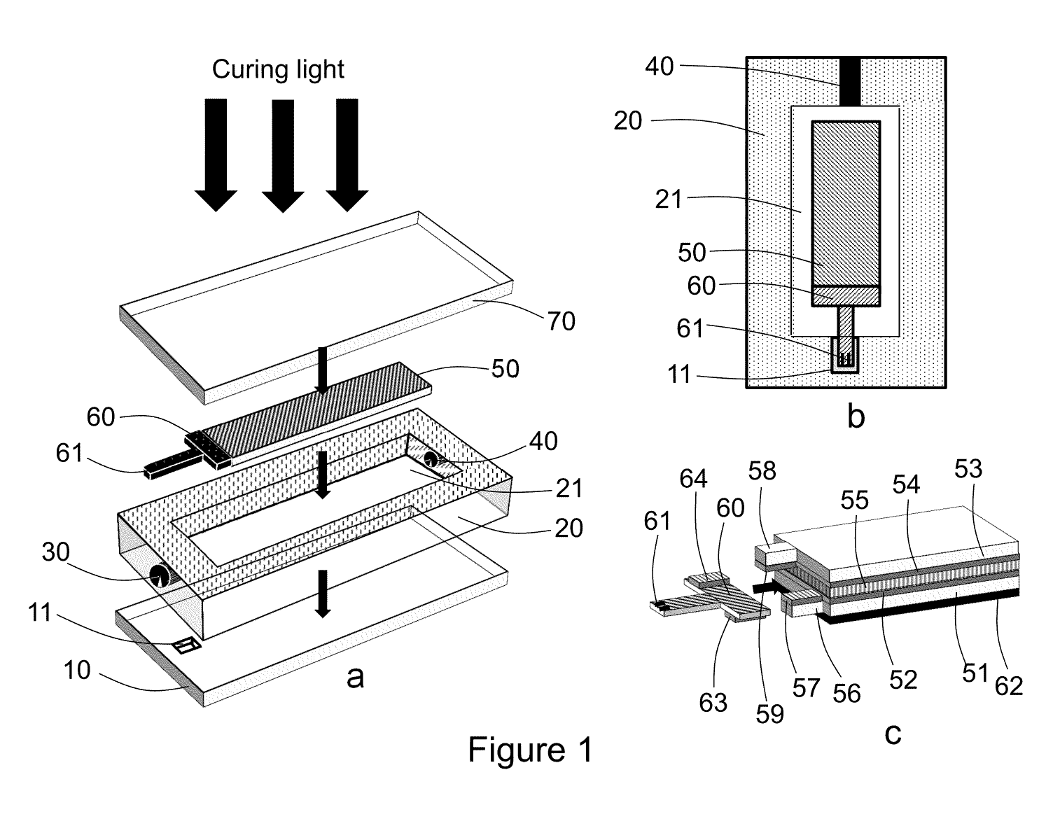

FIG. 1 shows a process of forming a protective casing on top of a flexible liquid crystal display made from plastic substrates. The molding process is illustrated In FIG. 1a where the mold includes a bottom part 10, middle part 20 with a cavity 21, injection port 30 and release port or vent 40 and a top part 70. The mold fits an electrooptical display 50 (e.g., a bistable cholesteric liquid crystal display) with bonded electrical interconnect, i.e., flex circuit or flexible interconnect 60. The display 50 rests on the plate 10. The top part 70 of the mold, middle 20 and bottom 10 parts, are made of optically transparent material to allow for light curing of the light curable material. Of course, it may be possible for only a portion of the mold to be light transmissive and still to be able to cure the entire light curable material. Top 70, middle 20 and bottom 10 parts can be secured together with clamps or with double sided PSA laminated around the perimeter of 10 and 20, or screwed or otherwise fastened together. The assembled mold containing the display device and injected light curable material on the display is exposed with the curing light to form a protective layer or casing on one side of the display (shown as a top of the display in this figure). The tab 61 of the flex circuit 60 can be hidden in a cavity notch 11, which can be formed in the bottom part 10 and/or in the middle part 20 of the mold to avoid being covered with cured light curable material as shown in FIG. 1b (note that injection port 30 is not shown for simplicity). The tab 61 can be also covered by tape or treated with silicone, for example, or with some other material to avoid being fixedly covered with cured light curable material. Avoiding cured light curable material from contacting the tab 61 allows further connection of flex circuit 60 to drive electronics.

A schematic view showing attachment of the flex circuit 60 to the display 50 is shown in FIG. 1c. The display includes top substrate 53 with conductive layer 54, bottom substrate 51 with conductive layer 52, light absorbing layer 62 as an outermost layer on one side of the display and liquid crystal 55 disposed between conductive layers. Flex circuit 60 with conductive tabs 64 and 63 can be attached to the display ledges 58 and 56 with conductive layers 59 and 57 with conductive double sided PSA, for example, with conductive epoxy, or some other conductive material. Conductive pads 64 and 63 can be also clamped to 59 and 57, respectively. Double sided PSA, conductive epoxy or other adhesive conductive material is placed between the tabs 63, 64 and the conductors 57, 59 on the ledges. Conductors travel inside the flex circuit 60 from the tabs 63, 64 to an exposed tab 61.

The depth of the cavity 21 defines the thickness of the casing formed on top (or bottom) of the display depending on whether the display is positioned face up or down in the mold and on the orientation of the mold. The interior mold surface is treated to prevent the light curable material from sticking. After placing the display into the mold and attaching the mold cover 70 made of optically transparent material, the light curable material is injected through the port 30. During the injection air is allowed to escape through the port 40. The filled mold is exposed to the curing light to cure the injected light curable material. After curing, the mold is disassembled and the display together with formed protective casing is ready for further processing (for forming a protective casing on another side, for example).

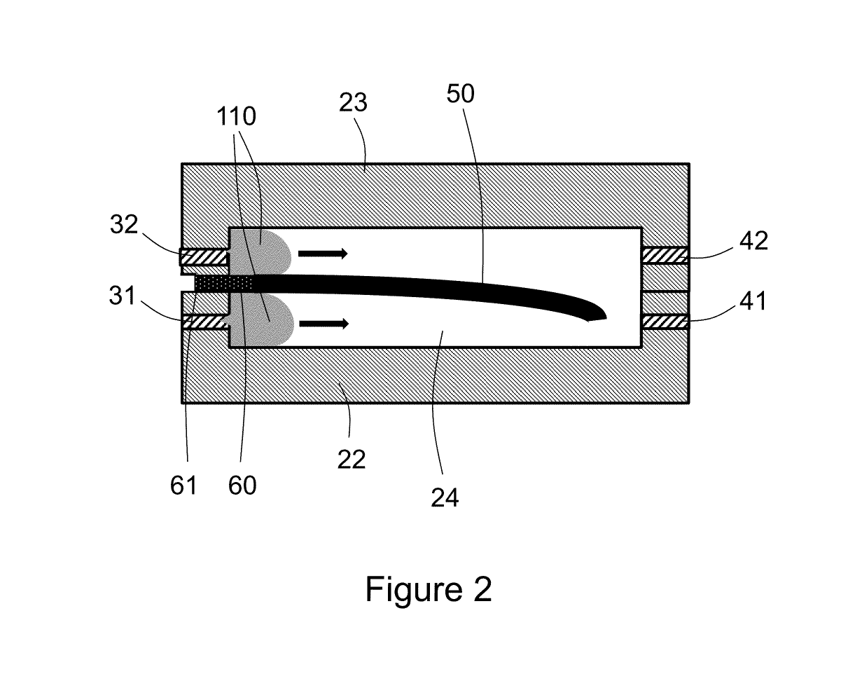

The process of FIG. 1a is also applicable to a single step injection mold where the display is fully encapsulated from both front and back sides in one step as shown schematically in FIG. 2. The mold includes optically transparent top part 23 and bottom part 22 made from silicone or acrylic, for example, or from other optically transparent material. The display 50 with flex circuit 60 is placed into mold cavity 24 so the tab 61 of flex circuit 60 is hidden by being sandwiched between top and bottom parts 22 and 23 to avoid being covered with cured light curable material. The light curable material 110 fills the cavity 24 through the injection ports 31 and 32 simultaneously forming a layer on the top and bottom of the display 50. Air is allowed to escape through the release ports 41 and 42. Initially, before filling a flexible display 50 may sag inside the mold as shown schematically in FIG. 2. However by flowing the material along the top and along the bottom of the display with equal pressure the display is pushed towards the middle of the cavity so the light curable material forms layers approximately of the same thickness on the top and on the bottom of the display. After filling the mold is exposed to the light to cure the light curable material through the optically transparent parts 22 and 23.

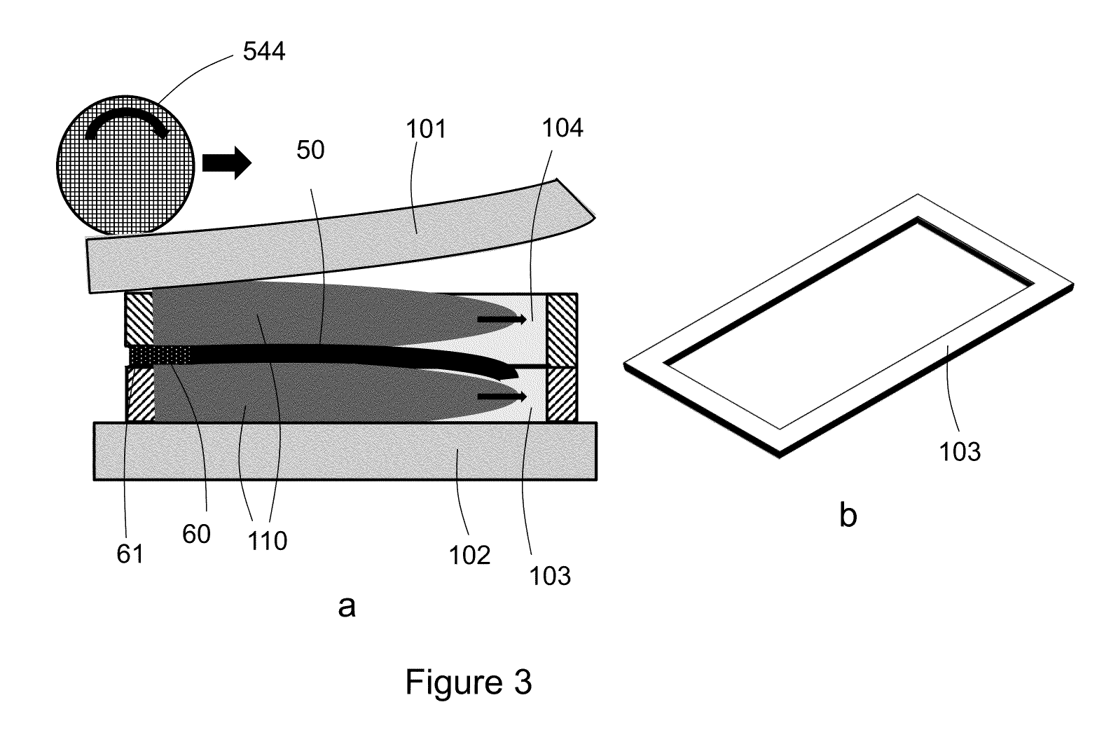

Full encapsulation can be also done as shown schematically in FIG. 3a. Display 50 with a flex circuit 60 is placed between two shims 103 and 104, each having a cavity shown schematically in FIG. 3b. The display area is smaller than the cavity formed by shims. Tab 61 of the flex interconnect is hidden by being positioned between the shims 103, 104 to prevent the tab from being covered with cured light curable material. A bead of light curable material 110 is dispensed inside the bottom cavity formed by shim 103 that is placed on substrate 102 as shown in FIG. 3a. The quantity of the light curable material is enough to fill the cavity formed by shim 103 fully. The display is fixed between the two shims on top of the light curable material in the lower shim. Light curable material 110 is dispensed inside the upper shim 104 as shown in FIG. 3a. The quantity of the light curable material is enough to fill the cavity formed by shim 104 fully. A flexible and optically transparent substrate 101 is laminated on top of the structure with a roller 544 applying a downward force. The flexible display may sag inside the cavity. However by flowing the material simultaneously along the top and bottom substrates of the display with equal pressure the display is pushed towards the middle of the cavity so the light curable material forms layers approximately of the same thickness on the top and on the back of the display. The excess of the material can escape through the gap between shims 103 and 104. After lamination the light curable material 110 is cured with light through the substrate 101 or through both 101 and 102 (if 102 is optically transparent). Substrates 101 and 102 can become a part of the laminated structure or can be released from the formed matrix after the curing process. The process explained in FIG. 3 can be automated utilizing a mechanical arm and dispenser.

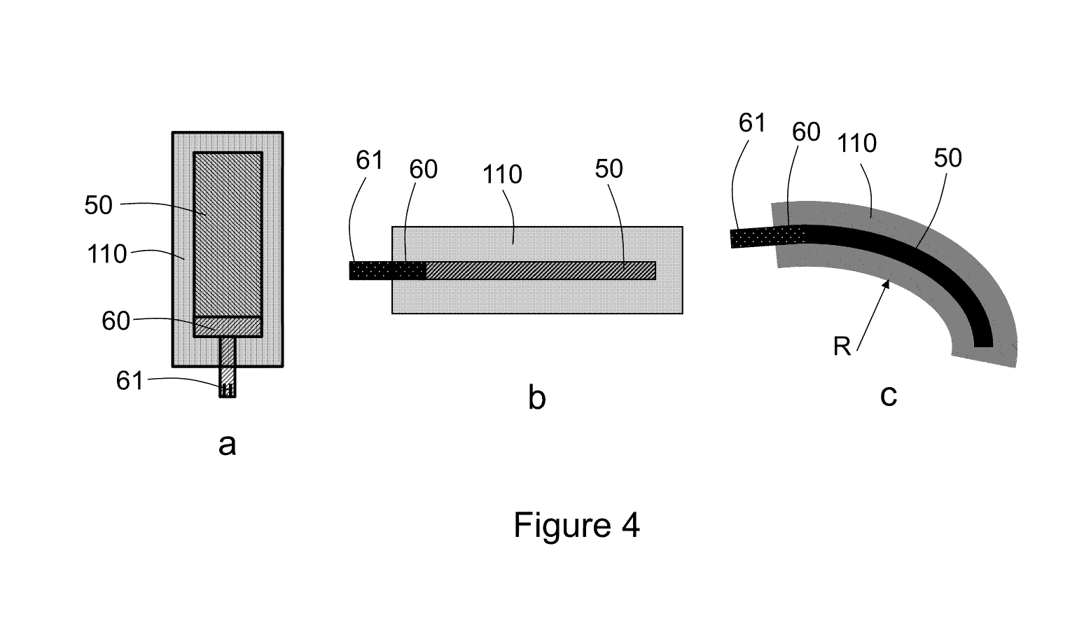

Schematic top and side views of the fully embedded display are shown in FIG. 4a and FIG. 4b, respectively. As shown, the tab 61 of the flex circuit 60 is free from the polymer matrix and can be further attached to drive electronics. The display can be electronically driven as described in U.S. Pat. Nos. 5,251,048, 5,644,330, 5,748,277, 5,889,566, 6,133,895 and 7,023,409, all of which are incorporated herein by reference in their entireties. If the polymer matrix is flexible then the embedded display can be flexed or conformed to some radius of curvature R as schematically shown in FIG. 4c.

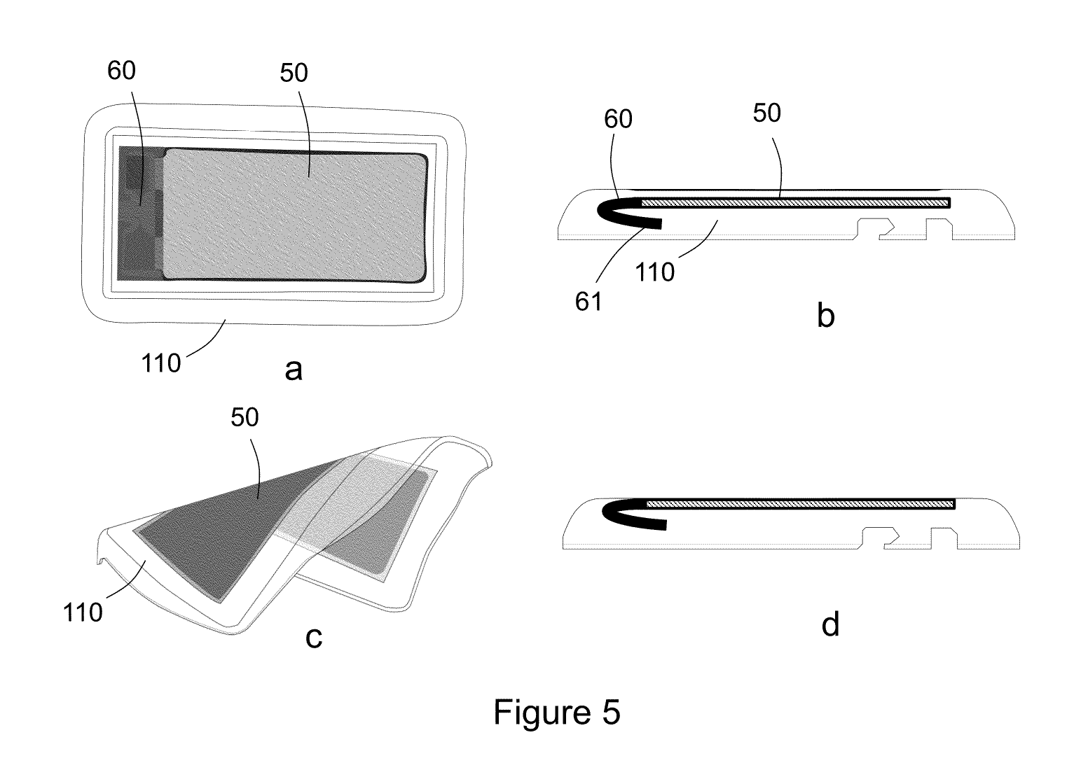

Depending on the mold shape the casing around the display can be molded in various shapes, even 3-D, as shown schematically in FIG. 5. Top and side views of the display 50 embedded into 3-D casing 110 in the shape of protective cover for a cell phone or MP3 player device are shown in FIGS. 5a and 5b, respectively. The embedded display of FIG. 5d can be a writing tablet display (e.g., the Boogie Board™ writing tablet sold by Kent Displays Inc.) in which one substrate is exposed outside of the protective layer, which can be written on. The display of FIG. 5b may be an electronic skin (e.g., Skin Flik™ electronic skin by Kent Displays Inc.) Flex circuit 60 can be bent and attached to drive electronics, which can be located behind the display. Drive electronics attached to the flex circuit can be embedded into the polymer matrix too. In this case the display can be switched capacitively (with appropriate electronics) or by pushing the button through the casing embedding the display. If the polymer matrix embedding the display is flexible then the embedded display remains flexible and can be conformed around some curvature as schematically shown in FIG. 5c.

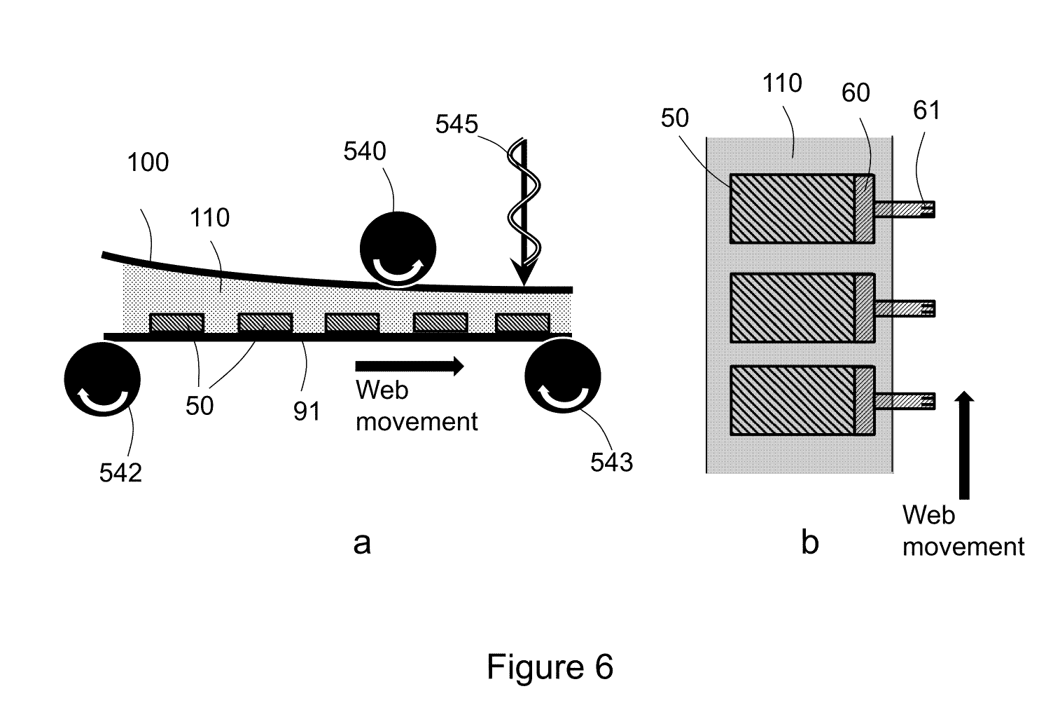

FIG. 6 shows a process of forming a protective casing on top of the displays on a roll-to-roll line. Again, the protective casing may be formed on either a top or a bottom of the display depending on whether the display is positioned face up or face down during the process. The light curable material 110 is flowed between bottom plastic film 91 carrying the displays 50 and top plastic film 100. Plastic films 91, 100 are moving in a conveyor-type motion by the rollers 540, 542, 543. The displays may be secured to the lower substrate 91 using adhesive, for example. The light curable material may flow between the substrates 100 and 91 and on and around the displays by applying pressure from a roller 540 against the substrate 100. Roller 540 also sets the thickness of the light curable material layer. Then the structure is sent through a light curing zone 545 to cure the light curable material and to form a protective casing on and around the displays. The individual displays embedded in the cured protective casing may be cut out from the cured protective casing surrounding the displays by a laser singulation process such as is described in U.S. patent application Ser. No. 11/756,987. The inner surfaces of the plastic films 91 and 100 may be treated with a silicone, for example, to prevent sticking of the cured light curable material to the surface or might be composed of a fluorinated polymer such as polyvinylidene fluoride (PVDF). After the light curing step, the plastic sheets 91 and 100 can be released, i.e., removed. If the light curable resin or either of the plastic films 91 and 100 (or both) are thermoformable, then the flat parts cut out from the web can be further thermoformed to desired shapes. To avoid damage of the display at high temperatures only the polymer matrix around the display (FIG. 4a) may be thermoformed to desired shapes.

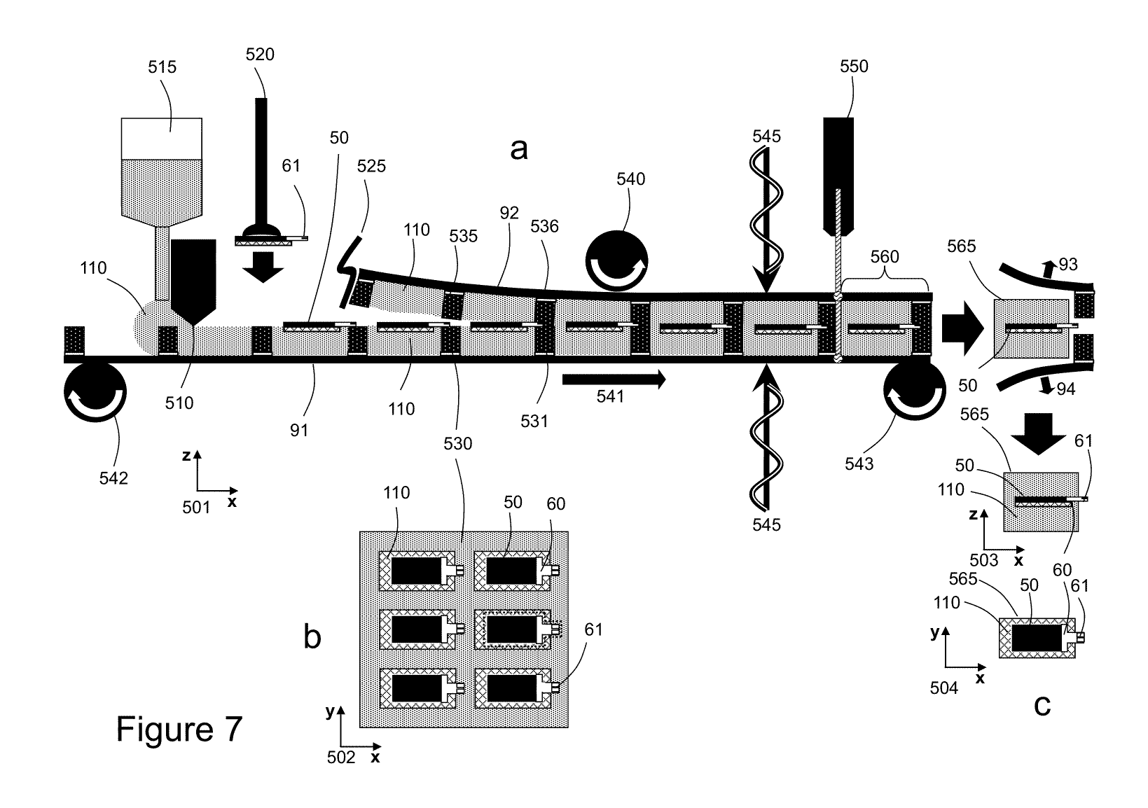

FIG. 7 shows a roll-to-roll process to completely embed the electrooptical display 50 simultaneously from the front and back sides. Front plastic film 92 and back plastic film 91 carried by the conveyor-type motion by rollers 540, 542 and 543 are each affixed to a plastic half-mold (535 and 530, respectively) using a pressure sensitive adhesive (536 and 531, respectively). The half molds include cavities for receiving the light curable material and the displays. Both the top and bottom sheets have the light curable material 110 dispensed 515 and knifed 510 over the half-mold plastic films 535 and 530 to fill in the cavities in them. Note that for clarity the dispense and knife processes are not shown for the upper plastic sheet 92 in the figure as indicated by the cut line 525. The knife and dispense process for the upper plastic sheet 92 is similar to the one described for the lower sheet 91. First film 92 is carried horizontally (not shown) in a conveyor-type motion but from right to left. Material gets dispensed and knifed between posts 535. Then plastic 92 makes a U-turn and gets into contact with the display and lower plastic 91 (shown in FIG. 7). Once the cavity of the lower half mold is filled with light curable material 110, a pick-and-place machine places the display 50 with bonded flex circuit 60 on top of the filled cavity on the bottom plastic sheet 91 such that the interconnect tab 61 rests directly over the bottom half-mold plastic film 530. The upper half molds filled with light curable material are aligned with the lower half filled molds. As the two coated plastic films 91 and 92 carrying the filled upper and lower half molds pass under the roll 540 during the lamination process 541, the top cavity of light curable material 110 comes in contact and wets out with the display 50 and any excess material is squished out in the opposite direction (−x direction) of the process 541. Next, the light curable material surrounding each display is light cured 545 from the front (top) and back (bottom) sides simultaneously, which forms embedded display modules. After curing, each embedded display module 560 is either singulated with a laser 550 or a die-cut (note that only is a laser is depicted in the figure). The laser can rapidly singulate each embedded display module to any desired shape. The embedded display module 560 already contains protection films (films 93 and 94) for shipment to the OEM customer for integration. Prior to integration, the protective front and back plastic sheets 93 and 94 are removed, respectively, which removes the upper and lower half molds that are adhered to the sheets. This removal of the molds exposes the interconnect tab 61 and the final embedded display part 565 can be integrated into the electronic device. If the light curable resin 110 or either of the plastic films 91 and 92 (or both) are thermoformable, then the flat parts cut out from the web can be further thermoformed to desired shapes by the customer or manufacturer for integration.

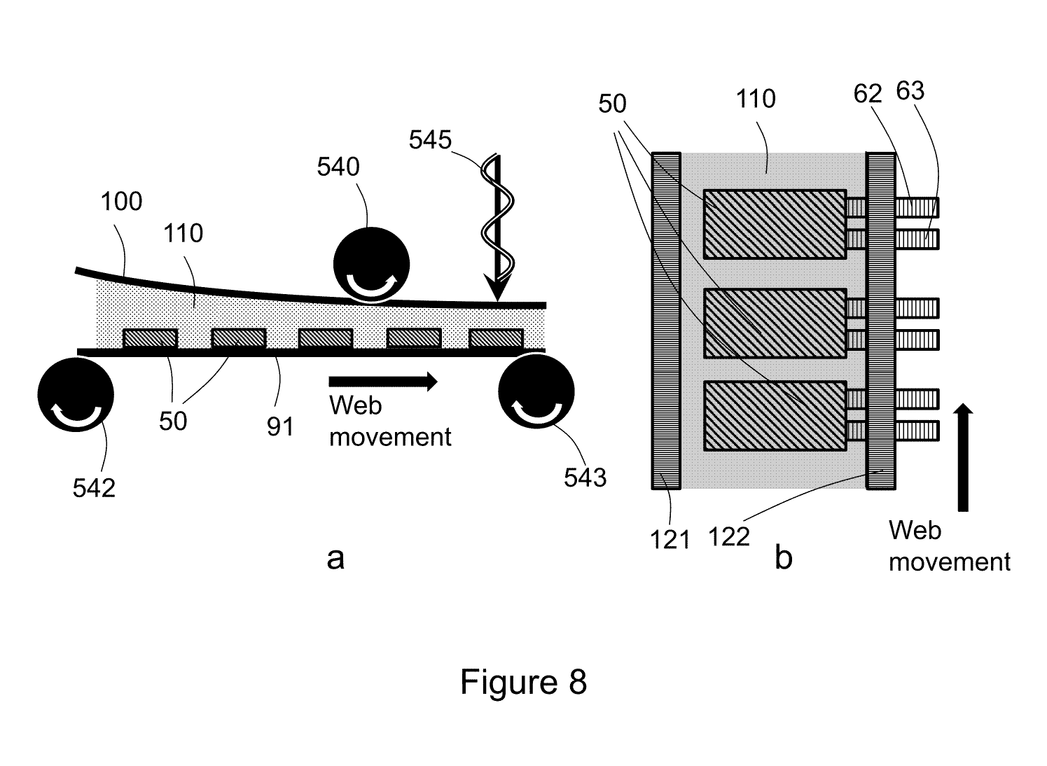

FIG. 8 shows a process of forming a protective casing fully embedding the displays on a roll-to-roll line in a two-step process. The detailed description of the process is given in the Example 5.

For manufacture and integration for consumer devices, the flat displays can be embedded either by the injection molding process (FIGS. 1, 2) or roll-to-roll processes (FIGS. 6-8). Once embedded, the display can be conformed, thermoformed, or even remolded and embedded into a 3-D shape using the injection mold process (FIG. 5). In addition, the display can be bonded to all electronics located behind the display and completely embedded into the 3-D shape. In such a configuration, the display can be switched capacitively such that the whole device is waterproof and completely sealed from the environment.

### EXAMPLES

### Example 1

A reflective cholesteric liquid crystal display was made by forming a liquid crystal layer by a polymerization induced phase separation (PIPS) technique (U.S. Pat. No. 7,351,506) between two 2 mil PET substrates with conductive polymer layers on a roll-to-roll line. The individual display was placed into a mold, shown in FIG. 1, which was made from two part SortaClear 40 silicone mold material (Smooth-On, Inc.). The mold was filled with optically clear flexible visible light curable material Delo-Dualbond OC VE 512438 (Delo Industrial Adhesives LLC, Sudbury, Mass.) mainly composed of acrylate monomers and oligomers and cured with a Delolux 20 visible light source with peak wavelength 400 nm, 1 min cure time. The mold was designed to prevent flex circuit tab 61 from being covered with light curable material. After forming the optically clear casing (0.5 mm thick) on the front side, the mold was disassembled, the display was turned upside down and placed into a mold like in FIG. 1 with a deeper cavity to form a clear protective layer on the back side. The embedded display with protective skin-like casing (about 1 mm thick) fully encapsulating the device as shown schematically in FIG. 4 is conformable to different curvatures. The embedded display can be flexed around an object, such as cylinder, with a R=10 mm radius of curvature (curvature k=1/R=0.1 mm⁻¹) without damage. The embedding procedure was also fulfilled utilizing Delo-Photobond OC VE 512642 adhesive from the same manufacturer.

### Example 2

A reflective cholesteric liquid crystal display was made by forming the liquid crystal layer by the PIPS technique described in U.S. Pat. No. 7,351,506 between two 2 mil PET substrates with conductive polymer layers on a roll-to-roll line. The 0.5 mm thick shim 103 with a cavity larger than the display area was placed on the bottom substrate 102 as schematically shown in FIG. 3. The optically clear flexible visible light curable material 110 (Delo-Dualbond OC VE 512438 material from Delo Industrial Adhesives LLC, Sudbury, Mass.) mainly composed of acrylate monomers and oligomers was dispensed into the cavity formed by 103. The display 50 was placed on top of the light curable material 110. Then the 0.5 mm thick shim 104 with a cavity larger than display area was placed on top of 103 and optically clear flexible visible light curable material 110 (Delo-Dualbond OC VE 512438 from Delo Industrial Adhesives LLC) was dispensed into the cavity formed by 104 (on top of the display). The roller 544 was rolled along the optically transparent flexible substrate 101 placed on top of the structure to set the thickness of the light curable material and remove the excess of the material. Both substrates 101 and 102 had silicone coatings on the surface to prevent sticking to the cured material. After flowing along both the front and back of the display the light curable material was cured with a Delolux 20 visible light source with peak wavelength 400 nm, 1 minute cure time from the top substrate and then another 1 minute cure time from the bottom substrate. The embedding process was designed to prevent the flex circuit tab 61 from being covered with light curable material. After forming the optically clear casing, the substrates 101 and 102 were released. The display with a 1 mm thick skin-like casing fully encapsulating the device is identical to that shown in FIG. 4 and can conform to different curvatures as shown in FIG. 4c. The embedded display can be flexed around an object, such as cylinder, with a 10 mm radius of curvature without damage. The embedding procedure was also fulfilled utilizing Delo-Photobond OC VE 512642 adhesive from the same manufacturer.

### Example 3

The optically clear protective casing in the shape of a protective skin-like case (about 1 mm thick) for a cell phone device or MP3 player was formed on the top of the reflective cholesteric liquid crystal displays in which the liquid crystal material made by a PIPS technique is disposed between two 2 mil PET substrates with conductive polymer layers on a roll-to-roll line. The individual display was placed into a mold made from two part SortaClear 40 silicone mold material (Smooth-On, Inc.) having a cavity in the shape of a protective case for a cell phone or MP3 player. The mold was filled with optically clear flexible visible light curable material Delo-Dualbond OC VE 512438 (Delo Industrial Adhesives LLC, Sudbury. MA) mainly composed of acrylate monomers and oligomers and cured with a Delolux 20 light source with peak wavelength 400 nm, 1 minute cure time from top and then another 1 minute cure time from the bottom part of the mold. After forming the case the mold was disassembled. The display embedded into the casing is schematically shown in FIG. 5. The formed casing together with embedded display can conform to different curvatures as shown FIG. 5c. The embedding procedure was also fulfilled utilizing Delo-Photobond AD494 adhesive from the same manufacturer.

### Example 4

A writing tablet liquid crystal display was made by forming a liquid crystal layer by a PIPS technique described in U.S. Pat. No. 6,104,448, U.S. patent application Ser. Nos. 12/152,729 and 12/220,805 and disposed between 5 mil PET top substrate and 7 mil PET bottom substrate with conductive polymer layers. The individual display was placed into a mold, shown in FIG. 1, which was made from two part SortaClear 40 silicone mold material (Smooth-On, Inc.). The mold was filled with optically clear flexible visible light curable material Delo-Dualbond OC VE 512438 (Delo Industrial Adhesives LLC, Sudbury, Mass.) mainly composed of acrylate monomers and oligomers and cured with a Delolux 20 visible light source with peak wavelength 400 nm, 1 minute cure time. After forming the optically clear casing (0.5 mm thick) on the back side of the display, the mold was disassembled. The optically clear UV curable material served to ruggedize a flexible writing tablet display from the back side leaving the front side non-covered with polymer matrix to allow for writing FIG. 5d. The mold can be designed to create a thin bezel (1-20 mm wide) around the perimeter of the front/active side of the writing tablet display. This bezel will help prevent the display from mechanical damage and delamination which may occur under mechanical deformation such as bending.

### Example 5

A reflective cholesteric liquid crystal display was made by forming a liquid crystal layer by a PIPS technique as described in U.S. Pat. No. 7,351,506 between two 2 mil PET substrates with conductive polymer layers on a roll-to-roll line. The displays were partially cut from the web with an area around the active area of the display being removed but the region of the web around the ledges remaining intact so the displays could be wound in a roll. The roll of displays were laminated to the carrier film 91 between two strips of 14 mil thick film 121 and 122 on the roll-to-roll line as schematically shown in FIG. 8. The top part of the displays 50 was then covered with optically clear flexible light curable material 110 (material LCR1000 from Sony Chemical and Information Device Corporation, Kanuma-city Tochigi-Pref., Japan) mainly composed of acrylate monomers and top carrier film 100 (FIG. 8a). Two ledges 62 and 63 of the displays 50 with conductive coatings for attaching electronic interconnects were extended beyond the shim 122 to avoid being covered with the light curable material. After filling the cavity formed between displays 50, carrier webs 91 and 100 and two shims 121 and 122 pressure was applied to the construction, then the light curable material was cured with low pressure mercury bulbs with peak wavelength 360 nm for 20 minutes. After forming the optically clear casing (10 mil thick) on the front side, the roll of displays were turned upside down. The carrier film 91 was removed. Another set of shims of 14 mil thick were laminated to the formed matrix 110. The formed cavity was filled with light curable material with a carrier film on top. Pressure was applied to the construction. Then the light curable material was cured with low pressure mercury bulbs with peak wavelength 360 nm for 20 minutes to form a 14 mil optically clear casing on the bottom side of the display. After the process the displays were fully embedded into an optically clear polymer matrix of approximately 28 mil thick (10 mil of the optically clear casing on the top, 14 mil of the optically clear casing on the bottom and 4 mil of display thickness). Individual displays were singulated from the protective layer sheet using a laser device as described in U.S. patent application Ser. No. 11/756,987. The embedded displays are conformable to different curvatures. The whole process described in this example, namely, display manufacturing, laminating of shims and displays to the carrier film 91, filling of the cavity with light curable material, laminating top carrier film 100, light cure of the material and then repeating all the steps to embed the other side of the displays into optically clear casing, was done using continuous roll-to-roll processes only, no manual labor was involved. The embedded display can be flexed around an object, such as cylinder, with a 10 mm radius of curvature without damage.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

What is claimed is:

1. A method of forming an embedded electrooptical display comprising
providing a mold that defines a cavity therein, wherein at least a portion of said mold is light transmissive;
placing an electrooptical display in said mold;
flowing light curable material into said cavity of said mold on and around said electrooptical display;
applying light through said light transmissive portion of said mold that cures said light curable material into a protective layer on and around said display forming an embedded said electrooptical display; and
removing said embedded electrooptical display from said mold.

2. The method of claim 1 comprising an electrical interconnect extending from said electrooptical display.

3. The method of claim 2 wherein said light curable material is prevented from contacting said electrical interconnect while said electrooptical display is in said mold.

4. The method of claim 1 wherein said electrooptical display includes an upper surface and a lower surface and only one of said upper surface and said lower surface contacts said light curable material.

5. The method of claim 1 wherein said electrooptical display includes an upper surface and a lower surface and both said upper surface and said lower surface contact said light curable material.

6. The method of claim 2 wherein a portion of said mold covers said electrical interconnect preventing said light curable material from contacting said electrical interconnect when said electrooptical display is in said mold.

7. The method of claim 2 wherein said electrical interconnect is covered with a non-stick material that said light curable material does not adhere to, comprising removing said light curable material adjacent said non-stick material to expose said electrical interconnect after said electrooptical display is removed from said mold.

8. The method of claim 1 wherein said electrooptical display is a liquid crystal display comprising two substrates each in contact with a layer of electrically conductive material and liquid crystal material disposed between said layers of electrically conductive material.

9. The method of claim 8 wherein said liquid crystal display includes bistable cholesteric liquid crystal material.

10. The method of claim 1 wherein said protective layer and said electrooptical display are flexible which enables said embedded electrooptical display to be flexible.

11. The method of claim 1 wherein said protective layer is optically clear.

12. The method of claim 1 comprising:
said protective layer being formed on one side of said electrooptical display;
removing said electrooptical display from said mold;
flipping said electrooptical display over;
inserting said electrooptical display into said mold so that the other side of said electrooptical display is exposed;
flowing light curable material into said cavity of said mold on the other side of said electrooptical display and around said electrooptical display into contact with said previously cured protective layer;
applying light through said light transmissive portion of said mold that cures said light curable material into a protective layer on the other side of said electrooptical display and around said electrooptical display forming a fully embedded said electrooptical display; and
removing said fully embedded electrooptical display from said mold.

13. The method of claim 1 wherein said protective layer is in contact with said electrooptical display.

14. The method of claim 6 wherein said mold includes mold sections that contact each other and said portion of said mold that covers said electrical interconnect includes a notch in one or both of said mold sections that receives said electrical interconnect, wherein said mold sections are in contact with each other outside of said notch.

15. A method of forming embedded electrooptical displays comprising
placing a first substrate on rollers;
providing a plurality of spaced apart electrooptical displays in fixed positions on said first substrate;
flowing light curable material onto said electrooptical displays and onto said first substrate around said electrooptical displays;
placing a second light transmissive substrate on said light curable material;
applying pressure that forces said first substrate and said second substrate toward each other;
applying light through at least one of said first substrate and said second substrate that cures said light curable material into a protective layer on and around said electrooptical displays forming embedded said electrooptical displays; and
cutting individual said embedded electrooptical displays from said cured protective layer.

16. The method of claim 15 comprising an electrical interconnect extending from each of said electrooptical displays outside of said light curable material, wherein said light curable material is prevented from contacting said electrical interconnects while said electrooptical displays are between said first and second substrates.

17. The method of claim 15 comprising removing said first and second substrates from said electrooptical displays.

18. The method of claim 15 wherein each of said electrooptical displays includes an upper surface and a lower surface and only one of said upper surface and said lower surface contacts said light curable material.

19. The method of claim 18 comprising flipping said first and second substrates over so that said second substrate is supported on said rollers; removing said first substrate; applying said light curable material on said electrooptical displays and on said protective layer around said electrooptical displays; placing a light transmissible third substrate on said light curable material; applying pressure moving said second substrate and said third substrate toward each other; applying light through said at least one of said second substrate and said third substrate that cures said light curable material into a second portion of said protective layer on said electrooptical displays.

20. The method of claim 19 wherein said cutting occurs through said protective layer and said second portion of said protective layer.

21. The method of claim 15 wherein said electrooptical displays are liquid crystal displays each comprising two substrates each in contact with a layer of electrically conductive material and liquid crystal material disposed between said layers of electrically conductive material.

22. The method of claim 21 wherein said liquid crystal material includes bistable cholesteric liquid crystal material.

23. The method of claim 15 wherein said protective layer and said electrooptical displays are flexible which enables said embedded electrooptical displays to be flexible.

24. The method of claim 15 wherein said first and second substrates are unwound from rolls.

25. The method of claim 15 wherein said protective layer is optically clear.

26. The method of claim 15 comprising using shims to inhibit flow of said light curable material from sides between said first substrate and said second substrate.

27. A method of forming embedded electrooptical displays comprising
placing a plurality of spaced apart first mold portions on rollers, each of said first mold portions defining a cavity;
flowing light curable material into said cavities of said first mold portions;
placing electrooptical displays on said light curable material in said first mold portions;
providing a plurality of spaced apart second mold portions, each of said second mold portions defining a cavity;
flowing light curable material into said cavities of said second mold portions;
aligning said second mold portions with said first mold portions;
applying pressure moving said first mold portions and said second mold portions toward each other so that said light curable material is disposed on both sides of said electrooptical displays;
applying light through at least one light transmissive portion of said first mold portions and said second mold portions that cures said light curable material into a protective layer on and around said electrooptical displays forming embedded said electrooptical displays;
cutting said embedded electrooptical displays from said protective layer; and
removing said first mold portions and said second mold portions.

28. The method of claim 27 comprising an electrical interconnect extending from each said electrooptical display which is sandwiched between said first mold portions and said second mold portions, wherein said light curable material is prevented from contacting said electrical interconnects while said electrooptical displays are disposed between said first and second mold portions.

29. The method of claim 27 wherein said electrooptical display is a liquid crystal display comprising two substrates each in contact with a layer of electrically conductive material and liquid crystal material disposed between said layers of electrically conductive material.

30. The method of claim 29 wherein said liquid crystal display includes bistable cholesteric liquid crystal material.

31. The method of claim 27 wherein said protective layer and said electrooptical displays are flexible which enables said embedded electrooptical displays to be flexible.

32. The method of claim 27 wherein said first and second mold portions each comprise a sheet having said cavities as cutouts on said sheet that is adhered to a first substrate and to a second substrate, respectively, said first and second substrates forming said light transmissive portions.

33. A method of forming an embedded electrooptical display comprising:
placing an electrooptical display between two mold sections each forming a cavity, at least one of said mold sections being light transmissive, said electrooptical display including an electrical interconnect, each of said mold sections including an inlet port and a vent;
securing said mold sections together so that said electrical interconnect is sandwiched between said mold sections and a portion of said electrooptical display near said inlet ports is near a center of said mold;
injecting light curable material into said inlet ports to flow into said mold sections simultaneously above and below said electrooptical display;
applying light through the at least one light transmissive mold section to cure said light curable material into a protective layer on both sides of said electrooptical display but not on said electrical interconnect; and
removing said embedded electrooptical display from said mold.

34. A method of forming an embedded electrooptical display comprising:
providing a lower shim enclosing a cavity and a lower film on which said lower shim is supported;
flowing light curable material in said cavity in said lower shim onto said lower film;
placing an electrooptical display on said light curable material in said lower shim;
providing an upper shim enclosing a cavity above said electrooptical display;
flowing light curable material in said cavity in said upper shim onto said electrooptical display;
providing an upper film in contact with said upper shim,
applying pressure moving said upper shim toward said lower shim so that said light curable material is disposed on both sides of said electrooptical display;
applying light through at least one light transmissive portion of at least one of said upper shim, said lower shim, said upper film and said lower film that cures said light curable material into a protective layer on and around said electrooptical display forming an embedded said electrooptical display; and
removing said upper shim, said upper film, said lower shim and said lower film from said embedded electrooptical display.

35. The method of claim 34 comprising placing an electrical interconnect of said electrooptical display between said upper shim and said lower shim to prevent said electrical interconnect from being covered with said light curable material.

36. A flexible embedded electrooptical display comprising an electrooptical display embedded on at least one side of said electrooptical display in a protective layer comprising light cured polymeric material, with the proviso that there is no layer having adhesive properties in contact with said electrooptical display.

37. The flexible embedded electrooptical display of claim 36 wherein said electrooptical display is a liquid crystal display comprising two substrates each in contact with a layer of electrically conductive material and liquid crystal material disposed between said layers of electrically conductive material.

38. The flexible embedded electrooptical display of claim 37 wherein said liquid crystal material includes bistable cholesteric liquid crystal material.

39. The flexible embedded electrooptical display of claim 36 comprising an electrical interconnect connected to said electrooptical display that includes a portion that is not embedded in said light curable polymeric material.

40. The flexible embedded electrooptical display of claim 37 comprising an electrical interconnect connected to said electrooptical display that includes a portion that is not embedded in said light curable polymeric material. wherein said electrical interconnect is electrically attached to said electrically conductive layers of said electrooptical display.

41. The flexible embedded electrooptical display of claim 40 wherein said electrically conductive layers include parallel lines of row electrodes on said one side of said liquid crystal material and parallel lines of column electrodes on said other side of said liquid crystal material, said row electrodes being substantially orthogonal to said column electrodes.

42. The flexible embedded electrooptical display of claim 40 wherein each of said electrically conductive layers forms an unpatterned sheet across a viewing area of said electrooptical display.

43. The flexible embedded electrooptical display of claim 36 which is a writing tablet in which one of said substrates upon which writing pressure is applied is exposed from said protective layer.

44. The flexible embedded electrooptical display of claim 36 bendable to a radius of curvature ranging from 10 mm to 70 mm and from −10 mm to −70 mm.

45. The flexible embedded electrooptical display of claim 36 bendable to a radius of curvature ranging from 10 mm to infinity and from −10 mm to infinity.

46. The flexible embedded electrooptical display of claim 36 wherein said protective layer includes a first protective layer portion on one side of said electrooptical display and a second protective layer portion on another side of said electrooptical display, said first protective layer portion and said second protective layer portion forming an integral body surrounding said electrooptical display.

47. The flexible embedded electrooptical display of claim 36 wherein said light cured material is optically clear.

48. A flexible embedded electrooptical display comprising an electrooptical display embedded on at least one side of said electrooptical display in a protective layer comprising light cured polymeric material, an electrical interconnect being connected to said electrooptical display which includes a portion that is not embedded in said light curable polymeric material.

49. The flexible embedded electrooptical display of claim 48 wherein said electrooptical display is a liquid crystal display comprising two substrates each in contact with a layer of electrically conductive material and liquid crystal material disposed between said layers of electrically conductive material, wherein said electrical interconnect is electrically attached to said electrically conductive layers of said electrooptical display.

50. The flexible embedded electrooptical display of claim 48 bendable to a radius of curvature ranging from 10 mm to 70 mm and from −10 mm to −70 mm.

51. The flexible embedded electrooptical display of claim 48 bendable to a radius of curvature ranging from 10 mm to infinity and from −10 mm to infinity.

52. A device incorporating said flexible embedded electrooptical display of claim 48 selected from the group consisting of a cell phone, smart phone, an MP-3 player, a computer mouse, a credit or debit card, an identification badge, a wall tile, a notebook cover, and a bracelet.
